(19) United States
(12) Patent Application Publication
(10) Pub. No.: US 2013/0113247 A1
(43) Pub. Date: May 9, 2013

(54) ADJUSTMENT DEVICE FOR MOTOR VEHICLE SEATS, IN PARTICULAR HEIGHT ADJUSTMENT DEVICES

(71) Applicants: Nils Magnus, Remscheid (DE); Markus Gumbrich, Solingen (DE)

(72) Inventors: Nils Magnus, Remscheid (DE); Markus Gumbrich, Solingen (DE)

(73) Assignee: C. ROB. HAMMERSTEIN GMBH & CO. KG

(21) Appl. No.: 13/698,622

(22) PCT Filed: Apr. 1, 2011
(86) PCT No.: PCT/EP2011/055115

§ 371 Date: Dec. 26, 2012

(30) Foreign Application Priority Data
May 19, 2010 (DE) 10 2010 029 129.3

(51) Int. Cl. B60N 2/427; B60N 2/16

(52) U.S. Cl. CPC B60N 2/42736; B60N 2/16
USPC 297/216.19

(57) ABSTRACT

The invention relates to an adjustment device for motor vehicle seats, in particular a height adjustment device, comprising a length-adjustable control unit which is suitable for adjusting and supporting a seat structure with respect to a seat base assembly and which can be articulated at one end to the seat structure and at the other end to the seat base assembly. In order to provide an adjustment device and a motor vehicle seat comprising an adjustment device, in which a bending direction of the adjustment device is predetermined in the event of a crash, the control unit is designed at least one of at one end and at both ends to be a pivotable and, in the event of a crash, slidable mounting with respect to at least one of the seat structure and the seat base assembly.

The invention relates to an adjustment device for motor vehicle seats, in particular height adjustment devices, comprising a length-adjustable control unit which is suitable for adjusting and supporting a seat structure with respect to a seat base assembly, and which can be articulated at one end to the seat structure, and at the other end to the seat base assembly. In addition, the invention relates to an adjustable motor vehicle seat with an adjustment device, in particular a height adjustment device.

Motor vehicle seats in today's vehicles have numerous adjustment options that allow the user to optimally adapt the motor vehicle seat to his or her needs. In addition to the manual adjustability of the motor vehicle seat, motor-driven adjustment devices are increasingly being used that enable the vehicle seats to be comfortably adjusted using corresponding control elements.

To adjust individual seat areas or respectively seat structures such as the seat surface, backrest, headrest, etc., length-adjustable control units are preferably used that enable the seat structures to be adjusted relative to each other or respectively to a seat base assembly by their adjustment in length. With a height-adjustment device, the adjustment device is preferably connected at one end to the seat structure to be adjusted, generally the seat pan, and at the other end to a seat base assembly, such as a seat upper rail, wherein a set height of the seat is determined by the set length of the control unit. A seat base assembly in the context of the application is understood to be an assembly connectable to a vehicle floor, in particular seat lower rails, seat upper rails, as well as components arranged thereupon.

The disadvantage of known adjustment devices, in particular length-adjustment devices having spindle drives, or the like that are arranged between the seat pan and the seat base assembly to adjust the height is the danger that the forces acting on the adjustment device in a rear-end vehicle collision cause the control unit, such as a nut-spindle system, to bend due to the arising inertia forces that are quite pronounced in particular when a motor drive unit is used. Depending on the direction of the bending resulting from the paths of the force, the ends of the bend can rise toward the seat pan under unfavorable conditions.

Various measures are known from the prior art to solve this problem such as using short spindle lengths for spindle drives, or reinforcing the components. However, these measures increase the amount of effort, weight and cost, with less favorable installation space.

The object of the invention is to provide an adjustment device as well as a motor vehicle seat having an adjustment device in which a bending direction of the adjustment device is predetermined in the event of a crash.

The object of the invention is achieved by an adjustment device having the features of claim 1, and by an adjustable motor vehicle seat having the features of claim 9. Advantageous further embodiments of the invention are indicated in the dependent claims.

The use of generic adjustment devices with length-adjustable control units for adjusting the height of motor vehicle seats makes it necessary for the adjustment device to be connected pivotally at both ends, that is, to the seat structure to be adjusted on the one hand, and the seat base assembly on the other hand. To achieve support with minimum play and a simple articulated connection, an arrangement of the articulation points is preferably provided on the longitudinal axis of the control unit that enables a purely pivoted connection of the adjustment device.

The invention is based on the knowledge that although in the case of such an arrangement the direction in which the control unit bends cannot be predicted in a rear-end or frontal collision in which axial forces acting via the seat structure act on the adjustment device and the control unit, however torque is generated when the arrangement of the pivot point deviates from the longitudinal axis of the control unit, for example on the seat base assembly, due to the forces acting in the direction of the longitudinal axis on the adjustment device, thus allowing the bending direction to be determined under a load.

According to the invention, the control unit is therefore designed to be borne at one and/or both ends in a pivoted manner and displaceable relative to the the seat structure and/or the seat base assembly in a crash. The pivoted bearing ensures smooth operation of the adjustment device in normal operation of the motor vehicle seat without any linear shifting of the control unit relative to the seat structure or the seat base assembly. However, the load-dependent shiftability of the adjustment unit relative to the seat structure and/or seat base assembly allows the control unit to shift once a specified force is reached, for example relative to a bearing bolt, pin, etc. that is provided for connecting with the seat structure and/or the seat base assembly, into a position that deviates from the longitudinal axis of the control unit. Consequently, the forces acting on the adjustment device in a crash generate torque about the displaced articulation point that determines the bending direction of the control unit.

The adjustment device according to the invention can therefore be easily and economically manufactured with preferably purely pivoted and hence play-free bearing in normal operation. When the load increases and bends the adjustment device, the adjustment device is shifted to a crash bearing point due to the shiftable bearing arranged different from the longitudinal axis of the control unit so that if bending arises under inertia forces, it occurs in the opposite direction of the seat pans. The ends of the bend therefore face away from the seat pan. In particular when a motorized drive unit is used, a bending direction can therefore be reliably predetermined even under the resulting increased inertia forces in a crash.

The length-adjustable design of the adjustment device can principally be realized in any manner; for example hydraulic or pneumatic systems are also conceivable. According to one particularly advantageous embodiment of the invention, the control unit has a threaded spindle, however, as well as a receiving unit with an inner thread adapted to the threaded spindle in which the threaded spindle is rotatably mounted, wherein the receiving unit can be connected articulated to the seat base assembly, and the threaded spindle to the seat structure.

This embodiment of the invention is characterized by a particularly simple and economical design. The length can be easily changed by rotating the threaded spindle relative to the receiving unit, wherein the nut-spindle mechanism enables very precise adjustment of the seat structure that is to he adjusted.

The adjustment device can be designed in principle on one and/or both ends to enable displaceable bearing in a crash. In a particularly advantageous embodiment of the invention, the receiving unit is designed to form a pivoted connection on a bearing axis of the seat base assembly at its end opposite the inner thread such that the control unit can shift relative to the bearing axis in a crash. In particular when a threaded spindle is used with a drive unit that is preferably arranged in the area of the end of the threaded spindle opposite the receiving unit, this embodiment of the invention is distinguished by being particularly easy to realize in this area, even though there is generally very little installation space at this location. The control unit being only borne in a pivoted manner on the seat structure also ensures a very reliable introduction of the forces arising in the crash, which can ensure in a particularly reliable manner that the collapsing components do not stand up when the control unit fails.

The control unit can be designed in any manner to realize pivoted bearing in normal operation and shiftable bearing relative to the seat structure and/or seat base assembly in a crash. According to one particularly advantageous embodiment of the invention, the receiving unit has a longitudinal bearing opening, preferably a slot, at its end opposite the inner thread to be mounted on a seat base assembly having a first normal bearing point preferably arranged on a longitudinal axis of the threaded spindle, and a second crash bearing point that deviates from the longitudinal axis of the threaded spindle and is arranged shifted relative to the normal bearing point toward the end of the receiving unit having the inner thread. According to this embodiment of the invention, the bearing opening in the receiving unit that is preferably designed as a slot has two bearing points set by the ends of the bearing opening or respectively the slot, that is, the normal bearing point, to operate the adjustment device in normal operation, and the crash bearing point by means of which the control unit is connected to the seat base assembly in a crash. The bearing element, for example a corresponding bearing bolt, pin, etc. arranged in the bearing opening for the articulation of the receiving unit to the seat base assembly can only shift after a previously specified force acting on the receiving unit or respectively control unit is exceeded given a corresponding embodiment of the bearing opening. As the case may be, access to the crash bearing point is released, thereby causing the control unit to shift under the exerted forces during which the bearing element passes from the normal bearing point to the crash bearing point. After it shifts relative to the longitudinal axis of the threaded spindle, the forces exerted in a crash in the direction of the longitudinal axis of and on the threaded spindle generate torque that determines the bending direction of the control unit when it fails. The use of a longitudinal bearing opening, especially a slot, is particularly easy and economical to design.

The design of the bearing opening is unrestricted to establish a purely pivoted arrangement of the control unit in normal operation with a bearing element being shifted in the bearing opening to the crash bearing point only under the increased forces that arise in a crash. According to one particularly advantageous embodiment of the invention, the bearing opening has a narrowing in an area between the normal bearing point and crash bearing point. This yields a reliable option for arranging a bearing element at the normal bearing point. The narrowing is designed such that it is displaced or respectively deformed under the increased forces from the bearing element acting on the control unit, thus causing a bearing element to shift in the crash bearing point. The narrowing can be designed very easily and economically, and it ensures a reliable, pivoted arrangement of the control unit to a seat base assembly, etc. in normal operation.

Alternately or in addition to designing the bearing opening with a narrowing, the bearing opening is closed by a deformation element in an area around the normal bearing point in an additional embodiment of the invention, and it is designed to deform in a crash and release access to the crash bearing point. According to this embodiment of the invention, the deformation element is arranged in the bearing opening such that, in normal operation, the bearing opening only releases the normal bearing point of the arrangement, and the forces arising during normal operation do not influence the deformation element. The deformation element is designed such that when increased forces arise in a crash, deformation occurs that allows a bearing element to access the crash bearing point, thus allowing a shift from the normal bearing point to the crash bearing point. The deformation element can be made of metals and/or plastics that are designed according to the forces arising in normal operation and in a crash.

As already represented above, the control unit can, in principle, be designed in any manner. In addition, the receiving unit for holding the threaded spindle can also in principle be designed in any manner. According to a particularly advantageous embodiment of the invention, it is however formed by a holding tube which, at one end, has the inner thread for receiving the threaded spindle and, at the other end, has a flattened area with the bearing opening. A holding tube according to this development of the invention can be manufactured in a particularly easy and economical manner. By using a holding tube, an inner thread adapted to the threaded spindle can be incorporated inside the holding tube which makes the adjustment device particularly easy and economical to manufacture.

When a threaded spindle arranged in a receiving unit is used the control unit is adjusted longitudinally by being rotated relative to the receiving unit. According to a particularly advantageous embodiment of the invention, the threaded spindle is rotatably arranged in a housing that can be connected in an articulated manner to the seat structure at its end facing away from the receiving unit, in which housing the threaded spindle can engage with a drive unit that drives it. This embodiment allows the control unit to be easily driven, and simultaneously ensures that the forces acting on the seat structure in a crash are reliably transmitted to the control unit via a pivoted connection of the housing to the seat structure, thus enabling the bending direction to be specified in a particularly reliable manner.

The motor vehicle seat according to the invention with an adjustment device, in particular a height adjustment device, is characterized in that the adjustment device is arranged at one end with the receiving unit on a bearing bolt arranged on the seat base assembly such that it extends through the normal bearing point of the receiving opening, and at the other end, the threaded spindle is arranged articulated to the seat structure via a housing that pivotably bears it.

The motor vehicle seat according to the invention is characterized in that the bearing bolt shifts in a crash from the normal bearing point in the receiving opening to the crash bearing point by using the above-described adjustment device and by arranging it on a bearing bolt arranged on the seat base assembly such that a specific bending movement arises, that is, in the direction of the seat base assembly, when the control unit of the adjustment device bends.

Exemplary embodiments of the invention will be explained in the following in more detail with reference to the drawings.

In the drawings:

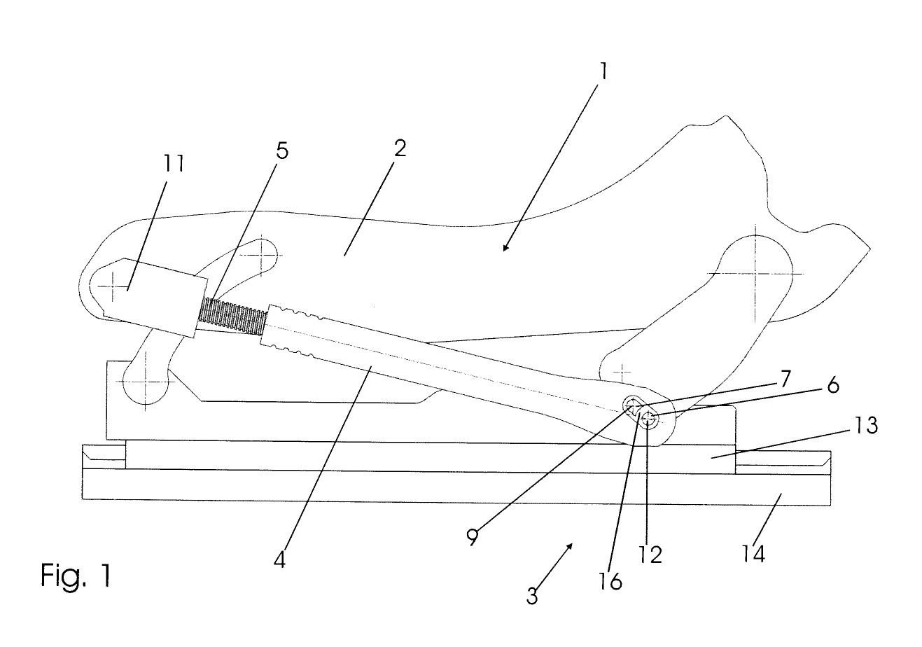

FIG. 1 shows a sketch of a side view of a section of a motor vehicle seat with an adjustment device arranged thereupon;

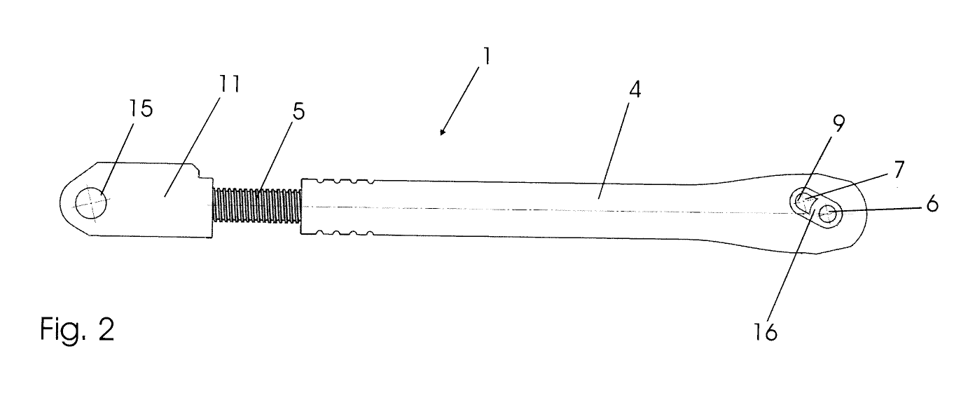

FIG. 2 shows a sketch of a side view of a control unit of the adjustment device from FIG. 1;

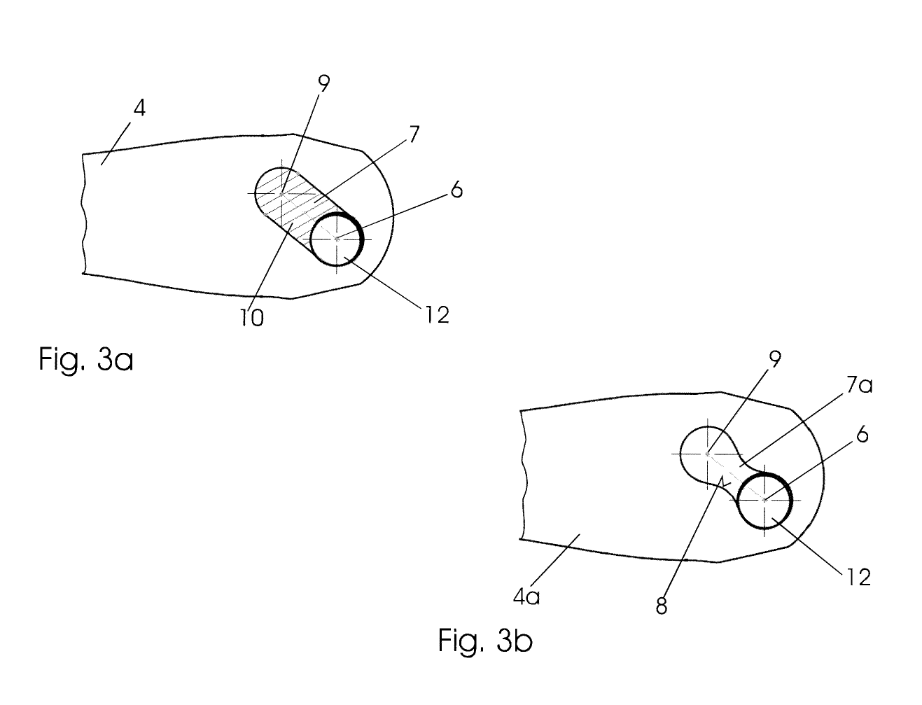

FIG. 3a shows a second embodiment of a design of a bearing opening of the control unit from FIG. 2, and

FIG. 3b shows a third embodiment of the bearing opening of the control unit from FIG. 2.

FIG. 1 schematically portrays a section of a motor vehicle seat having a control unit 1 of an adjustment device arranged thereupon. The control unit 1 extends between a seat structure 2 designed as a seat surface and a seat upper rail 13 of a seat base assembly 3, wherein the seat upper rail 13 is movably mounted relative to a seat lower rail 14 arranged on the vehicle floor.

The control unit 1 portrayed by itself in FIG. 2 that allows the seat height to be adjusted has a housing 11 on one end having a bearing opening 15 to receive a bearing bolt (not shown) for an articulated arrangement on the seat surface 2. A threaded spindle 5 of the control unit 1 is rotatably mounted in the housing 11, wherein the housing 11 is provided to accommodate a drive unit (not shown) for rotating the threaded spindle 5. The threaded spindle 5 is arranged in a receiving unit designed as a holding tube 4 at its end opposite the housing 11, wherein the holding tube 4 has an inner thread in its end facing the threaded spindle 5 and adapted thereto. Consequently, rotating the threaded spindle 5 while the holding tube 4 remains fixed causes the distance between the housing 11 to change relative to the holding tube 4.

At its end opposite the threaded spindle 5, the holding tube 4 has a flattened area in which a longitudinal bearing opening 7 is arranged. The bearing opening 7 has a normal bearing point 6 and a crash bearing point 9. The normal bearing point 6 and the bearing opening 15 of the housing 11 are arranged on the longitudinal axis of the threaded spindle 5 such that when the length of the control unit 1 changes as the threaded spindle 5 rotates, the control unit 1 can execute an unimpeded swinging motion relative to the seat base assembly 3 and the seat surface 2.

The access to the crash hearing point 9 proceeding from the normal bearing point 6 is blocked by a plastic element 16 introduced and preferably clipped into the bearing opening 15, and when a predetermined force arising in a crash is reached, the plastic element 16 is breached, thus enabling the hearing bolt 12 to shift.

The bearing opening 7 is designed as a slot, wherein a crash bearing point 9 that is arranged in the slot opposite the normal bearing point 6 is arranged shifted in a different direction from the longitudinal axis of the threaded spindle 5. When a bearing bolt 12, by means of which the holding tube 4 is articulated to the seat base assembly 3, is arranged in the crash bearing point 7, torque is generated from the force arising in a crash that is exerted in the direction of the longitudinal axis of the threaded spindle 5, and it determines the bending direction when the control unit 1 bends, that is, toward the seat base assembly 3.

An alternative embodiment of the subdivision of the bearing opening 7 portrayed in FIGS. 1 and 2 is shown in FIG. 3a. To ensure that the bearing bolt 12 is only displaced in a crash, the bearing opening 7 is not sealed with a plastic element 16 but rather with a deformation element 10 which is designed to deform under previously specified forces corresponding to those in a crash, which cause the bearing bolt 12 to move from the normal bearing point 6 to the crash bearing point 9.

An alternative embodiment of the bearing opening 7 is shown in FIG. 3b. The bearing opening 7a has a narrowing 8 that extends between the normal bearing point 6 and the crash bearing point 9, and this prevents the bearing bolt 12 from shifting in the bearing opening 7a during normal operation. The narrowing 8 is designed such that the forces acting on the narrowing 8 cause it to deform only when the elevated forces that arise in a crash occur, thereby enabling the bearing bolt 12 to shift to the crash bearing point 9.

1. An adjustment device for motor vehicle seats, comprising:
a length-adjustable control unit which is suitable for adjusting and supporting a seat structure with respect to a seat base assembly, and which can be articulated at one end to the seat structure, and at the other end to the seat base assembly,
wherein the control unit is designed at least one of at one end and at both ends to be borne in a pivoted manner, and in a shiftable manner relative to at least one of the seat structure and the seat base assembly in a crash.

2. The adjustment device for motor vehicle seats according to claim 1, wherein the control unit has a threaded spindle and a receiving unit with an inner thread adapted to the threaded spindle in which the threaded spindle is rotatably mounted, wherein the receiving unit is articulatable to the seat base assembly, and the threaded spindle is articulatable to the seat structure.

3. The adjustment device for motor vehicle seats according to claim 2, wherein the end of the receiving unit opposite the inner thread is designed to be connected in a pivoted manner to a bearing axis of the seat base assembly so that the control unit can shift relative to the bearing axis in a crash.

4. The adjustment device for motor vehicle seats according to claim 2, wherein the end of the receiving unit opposite the inner thread has a longitudinal bearing opening, preferably a slot, for being borne on the seat base assembly with a first normal bearing point preferably arranged on a longitudinal axis of the threaded spindle, and a second crash bearing point that deviates from the longitudinal axis of the threaded spindle and is arranged shifted relative to the normal bearing point toward the end of the receiving unit having the inner thread.

5. The adjustment device according to claim 4, wherein the bearing opening has a narrowing in an area between the normal bearing point and the crash bearing point.

6. The adjustment device according to claim 4, wherein the bearing opening is closed in an area around the normal bearing point by a deformation element that is designed such that it deforms in a crash and releases access to the crash bearing point.

7. The adjustment device according to claim 2, wherein the receiving unit is formed by a holding tube that has the inner thread at one end to receive the threaded spindle and a flattened area at the other end having the bearing opening.

8. The adjustment device according to claim 2, wherein the end of the threaded spindle facing away from the receiving unit is rotatably arranged in a housing that can be articulated to the seat structure and in which the threaded spindle can be engaged with a driving unit that drives it.

9. An adjustable motor vehicle seat having an adjustment device, according to claim 2, wherein one end of the adjustment device with the receiving unit is arranged on a bearing bolt arranged on the seat base assembly such that it extends through the normal bearing point of the seat opening, and at the other end, the threaded spindle is arranged in an articulated manner on the scat structure by means of a housing that pivotably bears it.
